(19) United States
(12) Patent Application Publication
(10) Pub. No.: US 2017/0232388 A1
(43) Pub. Date: Aug. 17, 2017

(54) OSMOTICALLY ATTAINED HIGH QUALITY BOILER MAKE-UP WATER

(71) Applicant: James Jeffrey Harris, Cameron Park, CA (US)

(72) Inventor: James Jeffrey Harris, Cameron Park, CA (US)

(21) Appl. No.: 15/430,180

(22) Filed: Feb. 10, 2017

Related U.S. Application Data
(60) Provisional application No. 62/294,675, filed on Feb. 12, 2016.

(51) Int. Cl. B01D 61/00; C02F 1/44

(52) U.S. Cl. CPC B01D 61/005; B01D 61/002; C02F 1/445; B01D 2311/2673; C02F 2103/023

(57) ABSTRACT

A water mass transfer process providing a method and system to benefit conversion of poor quality water to attain high quality feed water or make-up water for a boiler. Wherein a low volatile solute is imbued within the water of a boiler, sufficiently so the elevated osmotic pressure of the boiler water can serve as a draw solution for forward osmosis based extraction of clean, high quality make-up water from poor quality water sources.

### CROSS-REFERENCE TO RELATED APPLICATIONS

This non-provisional patent application claims priority based upon prior U.S. Provisional Patent Application Ser. No. 62/294,675 filed Feb. 12, 2016, in the name of James Jeffrey Harris, entitled “Osmotically Obtained High Quality Boiler Makeup Water,” the disclosure of which is incorporated herein in its entirety by reference as if fully set forth herein.

### BACKGROUND OF THE INVENTION

The art of the present invention relates to methods and systems for providing high quality make-up water to a water heater or boiler by employ of enhanced osmotic provision of high quality feed water, from a poor quality source through one or more forward osmosis processes.

Currently, water is heated in boilers to generate steam and/or water vapor facilitating heating and/or other process services. Water lost to process use or leakage must be replaced with make-up-water. Pipes, heating surfaces, valves, pumps, and other boiler related equipment will fail if high quality make-up water is not employed.

Assurance of high quality make-up water generally requires expensive and complicated processes, especially when the make-up water is from a low quality source. In some water source situations, the complexity and cost of generating acceptable boiler make-up water is prohibitive. The invention provides a simple, straightforward method and systems for providing high quality boiler make-up water from a poor quality water source.

The technology described in issued U.S. patents involve complicated means for generating quality boiler makeup water. Examples of employing steam collection are numerous. For example, U.S. Pat. No. 4,177,767 issued to Regamy, U.S. Pat. No. 4,249,486 issued to Potochnik, and U.S. Pat. No. 4,878,457 issued to Bekedam all describe processes that are complicated, expensive and often not possible when steam is consumed in the process. Other complicated chemical or chemical and mechanical processes have been described such as U.S. Pat. No. 9,169,144 issued to Blumenschein, U.S. Pat. No. 7,608,190 issued to Banerjee, et al., U.S. Pat. No. 7,815,804 issued to Nagghappan, and U.S. Pat. No. 8,349,188 issued to Soane, et al.

The methods and systems in the prior art can achieve generation of sufficient quality boiler make-up water from poor water quality sources albeit through complicated and expensive means. There is a need, however, for methods and systems that resolve the complexities and costs associated with the prior art and provides these benefits with a simple and robust process.

### SUMMARY OF THE INVENTION

The methods and processes of the present invention are directed toward the use of poor quality water sources for boilers, heaters and other similar devices (collectively referred to as boilers) make-up water needs. Various embodiments of the invention employ one or more high temperature amenable solutes entrained within the boiler water. Embodiments further employs one or more forward osmosis appliances and/or processes, such as, but not limited to, semipermeable membranes, so configured to separate the solute imbued boiler water from the poor quality boiler make-up. An osmotic pressure differential, imparted by the solutes in the boiler water, compels transfer of high quality, clean water from the poor quality water sources through the forward osmosis appliance/processes and into, and thereby diluting and volumetrically supplementing, the boiler water.

In certain embodiment of the invention, one or more solutes are entrained within the water in a boiler. These solutes induce an osmotic pressure differential relative to the make-up water presented to the boiler. The solutes are preferentially further characterized as being amenable to the relatively high temperatures associated with boiler operation, acquiescing with, but not limited to, the beneficial traits of chemical stability, low vapor pressure, non-corrosive, as well as low fouling and or scaling tendencies. Boiler operation vaporizes the water phase of the solute solution, generating relatively solute free vapor (steam) for external process use. Vapor discharge imbues a continual loss of water from the boiler and a concurrent concentration of the entrained solutes. The concentration effected by vaporization enhances the osmotic pressure imbued by the solutes. This embodiment exploits the enhanced osmotic pressure by means of one or more forward osmosis processes, such as, but not limited to, semipermeable membrane processes, by continual or intermittent osmotic drawing of high quality, clean water away from the poor quality water sources into the higher osmotic pressure solute concentrate, reducing the concentration and the associated osmotic pressure while replenishing the boiler water lost to vaporization.

Some embodiments of the invention may also employ ancillary equipment or processes such as, but not limited to, one or more heat exchangers providing thermal conditioning of the concentrated solute boiler water and/or the poor quality feed water to temperatures beneficial for the forward osmosis processes and/or boiler processes, boiler water filtration, boiler water blow down control equipment, boiler water pumps, deaerators, chemical addition or processes for conditioning of the boiler water to minimize scaling, fouling or plugging of the boiler and/or the forward osmosis processes, the heat exchangers or any other equipment or processes associated with operation of the invention.

The invention operates with either solid solutes such as, for example, metal salts such as magnesium sulfate or liquid solutes, such as, but for example, triethylene glycol.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the subject art, and the advantages thereof, reference is now made to the following descriptions taken in conjunction with the accompanying figures, wherein:

FIG. 1 shows a flow diagram in which a concentrated, high osmotic pressure boiler water is volumetrically supplemented with high quality water from a low quality, low osmotic pressure water source by means of a forward osmosis process; and

FIG. 2 shows a flow diagram in which concentrated, high osmotic pressure hot water from a boiler is cooled by heat exchange with a cooled and volumetrically supplemented high quality, lower osmotic pressure water returning to the boiler from a forward osmosis process.

### DETAILED DESCRIPTION

The application, usage, and benefits of various embodiments of the present invention are discussed in detail below. It should be appreciated, however, that the subject art provides many applicable inventive concepts that can be embodied in a wide variety of specific contexts. The specific embodiments discussed are merely illustrative of specific ways to make and use the subject art, and do not limit its scope.

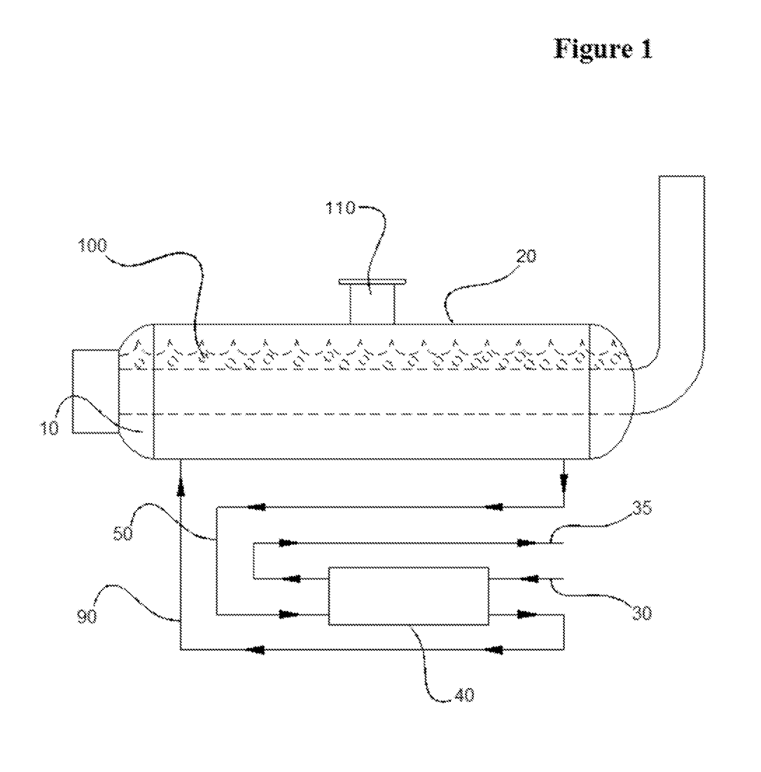

With reference now to FIG. 1 which depicts a solid or liquid solute being added to boiler water 100 contained within one or more boilers 20 to enhance the osmotic pressure of the boiler water 100. As water vapor conveys 110 from the boilers, the volume of the boiler liquid water 10 will decrease and the solute concentration and osmotic pressure will increase. This higher osmotic pressure boiler water is conveyed 50 to one or more forward osmosis processes 40 wherein the higher osmotic pressure of the boiler water extracts high quality water from one or more low quality, low osmotic pressure water sources 30 thereby providing a volumetrically enhanced, high quality water 90 for resupply to the boilers 20. The low quality, low osmotic pressure water 30 supplied to the forward osmosis processes 40 are concentrated and volumetrically reduced commensurate to the volumetric increase of the high quality water 90 returned to the boilers 20. Concentrated, volumetrically reduced, poor quality waters are conveyed 35 from the forward osmosis processes 40 for further use or discharge.

As a furtherance to the process representation of FIG. 1, with sufficient turbulence of the boiler water 10, a nearly steady state solute concentration in the boiler water 10 can be achieved wherein the correlating, steady state, high osmotic pressure of the boiler water 50 is conveyed to one or more forward osmosis processes 40 extracts high quality water from one or more low quality, lower osmotic pressure water sources 30. Volumetrically enhanced, high quality water 90 is conveyed back to the boilers 20 and volumetrically reduced and concentrated low quality water 35 is conveyed from the forward osmosis processes 40 for further use or discharge.

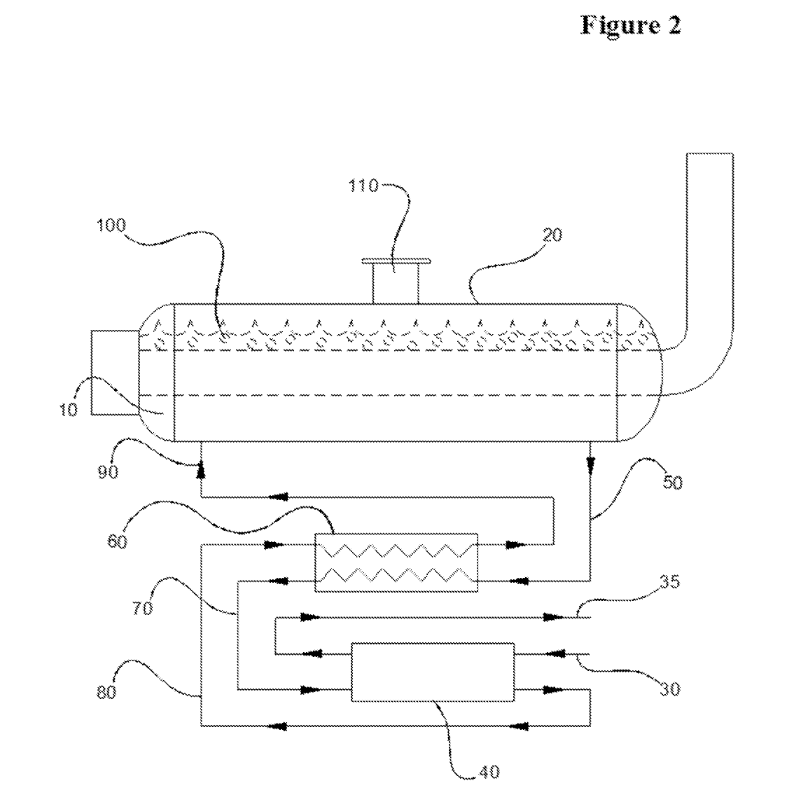

FIG. 2 depicts another embodiment of the invention wherein one or more forward osmosis processes are temperature constrained. A solid or liquid solute is added to boiler water 100 contained within one or more boilers 20 to enhance the osmotic pressure of the boiler water 10. As water vapor 110 conveys from the boilers, the volume of the boiler liquid water 10 decreases and the solute concentration and osmotic pressure increases. This hot, high osmotic pressure boiler water 50 is conveyed to one or more heat exchange processes 60 wherein the hot, high osmotic pressure boiler water 50 is cooled by cool, high quality, volumetrically enhanced, lower osmotic pressure boiler water 80 returning toward the boilers from one or more forward osmosis processes 40. The cooled, high osmotic pressure boiler water 70 conveys to one or more forward osmosis processes 40 wherein the high osmotic pressure of the boiler water extracts high quality water from one or more low quality, low osmotic pressure water sources 35 thereby volumetrically enhancing the boiler water 80 returning toward the boiler 20. The cooled, volumetrically enhanced boiler water 80 is reheated in one or more heat exchangers 60 while concurrently cooling the boiler water 50 from the boilers 20. The volumetrically enhanced, reheated boiler water 90 then returns to the boilers 20. Volumetrically reduced and concentrated poor quality water 35 is conveyed from the forward osmosis processes 40 for further use or discharge.

As a furtherance to the process representation of FIG. 2, with sufficient turbulence of the boiler water 10, a nearly steady state solute concentration in the boiler water 10 can be achieved wherein the correlating, steady state, high temperature, high osmotic pressure boiler water 50 is conveyed to one or more heat exchange processes 60 wherein the hot, steady state, high osmotic pressure boiler water is cooled by cool, high quality, volumetrically enhanced, lower osmotic pressure boiler water 80 returning toward the boilers from one or more forward osmosis processes 40. The cooled, steady state, high osmotic pressure boiler water 70 conveys to one or more forward osmosis processes wherein the high osmotic pressure of the cooled boiler water extracts high quality water from one or more low quality, low osmotic pressure water sources 35, thereby volumetrically enhancing the boiler water 80 returning toward the boiler 20. The cooled, volumetrically enhanced boiler water is reheated in one or more heat exchangers 60 while concurrently cooling the boiler water 50 from the boilers 20. The volumetrically enhanced, reheated boiler water 90 then returns to the boilers 20. Volumetrically reduced and concentrated poor quality water 35 is conveyed from the forward osmosis processes 40 for further use or discharge.

As will be apparent to those skilled in the art, steam vapor is created without the necessity for high quality feed water. The associated benefits are many, but not limited to; water savings because of reduced boiler blowdown, reduced boiler chemical treatment, reduced boiler maintenance, elimination of internal scaling and fouling of boilers, energy savings from enhanced boiler efficiency and beneficial use of a poor quality water source.

While the present device has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible methods and systems available for improving the quality of make-up water, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method of vaporizing water employing poor quality feed water comprising:
vaporizing a water solution imbued with osmotic pressure enhancing solutes, wherein vaporizing concentrates the osmotic solutes thereby increasing the osmotic pressure of the water solution;
conveying the vaporized water externally for other process use;
conveying the concentrated and increased osmotic pressure water solution to one or more forward osmosis appliances;
conveying additional water of insufficient quality to the one or more forward osmosis appliances;
employing the concentrated and increased osmotic pressure water solution as a draw solution for the one or more forward osmosis appliances;
extracting clean water from the water of insufficient quality by forward osmosis in the one or more forward osmosis appliances;
blending the extracted clean water with the solute draw solution to form a solute solution;
diluting and expanding the volume of the solute solution;
concentrating and reducing the volume of water of insufficient quality;
conveying the diluted and expanded volume of solute solution to vaporization;
remediating the vaporized loss of water by supplication of the diluted and expanded volume of solute solution returning to vaporization; and
conveying the concentrated and reduced volume of insufficient quality water to disposal or other use.

2. The method of claim 1 wherein vaporization is thermally driven.

3. The method of claim 1 wherein vaporization is pressure driven.

4. The method of claim 1 wherein the vaporization is thermally and pressure driven.

5. The method of claim 1 wherein the solutes are one or more metal salts.

6. The method of claim 1 wherein the solutes are one or more glycol solutions.

7. The method of claim 1 wherein the solutes are one or more water soluble, non-glycol organic solutions.

8. The method of claim 1 wherein the solutes are one or more water soluble, inorganic solutions.

9. The method of claim 1 wherein the forward osmosis appliance employs one or more semipermeable membranes.

10. The method of claim 1 wherein vaporizing and remediation by supplication of the diluted and expanded volume of solute solution returning to vaporization facilitates steady state average concentration during vaporization.

11. A method of vaporizing water employing poor quality feed water comprising:
vaporizing a water solution imbued with one or more osmotic pressure enhancing solutes, wherein vaporizing concentrates the osmotic solutes thereby increasing the osmotic pressure of the water solution;
conveying the vaporized water externally for other process use;
conveying the concentrated and increased osmotic pressure water solution to one or more heat exchange appliances;
cooling the concentrated and increased osmotic pressure solution;
conveying the cooled, concentrated and increased osmotic pressure water solution to one or more forward osmosis appliances;
conveying additional water of insufficient quality to the one or more forward osmosis appliances;
employing the concentrated, higher osmotic pressure water solution as draw solution for the one or more forward osmosis appliances;
extracting clean water from the water of insufficient quality by forward osmosis using the one or more forward osmosis appliances;
blending the extracted clean water with the solute solution;
diluting and expanding the volume of the solute solution;
concentrating and reducing the volume of the water of insufficient quality;
conveying the dilute and expanded volume of solute solution to one or more heat exchange appliances;
warming the dilute and expanded volume of solute solution by heat exchange with the concentrated and increased osmotic pressure water solution conveyed from vaporization;
conveying the warmed, dilute and expanded volume solute solution to vaporization;
remediating the vaporized loss of water by supplication of the diluted and expanded volume of solute solution returning to vaporization; and
conveying the concentrated and reduced volume of insufficient quality water to disposal or other use.

12. The method of claim 11 wherein vaporization is thermally driven.

13. The method of claim 11 wherein vaporization is pressure driven.

14. The method of claim 11 wherein vaporization is thermally and pressure driven.

15. The method of claim 11 wherein solutes are one or more metal salts.

16. The method of claim 11 wherein solutes are one or more glycol solutions.

17. The method of claim 11 wherein solutes are one or more non-glycol water soluble organic solutions.

18. The method of claim 11 wherein the forward osmosis appliances employ one or more semipermeable membranes.

19. The method of claim 11 wherein vaporizing and remediation by supplication of the diluted and expanded volume of solute solution returning to vaporization facilitates steady state average concentration during vaporization.
